(19) United States
(12) Patent Application Publication
(10) Pub. No.: US 2010/0200239 A1
(43) Pub. Date: Aug. 12, 2010

(54) FRICTION REDUCING COMPOSITIONS FOR WELL TREATMENT FLUIDS AND METHODS OF USE

(75) Inventor: Carl Wilhelm Aften, Marietta, GA (US)

Correspondence Address: CANTOR COLBURN, LLP, 20 Church Street, 22nd Floor, Hartford, CT, 06103, US

(73) Assignee: Kemira Chemicals, Inc., Kennesaw, GA (US)

(21) Appl. No.: 12/367,721

(22) Filed: Feb. 9, 2009

(51) Int. Cl. C09K 8/86; E21B 43/26; E21B 43/267

(52) U.S. Cl. 166/308.2; 507/243; 507/247

(57) ABSTRACT

Friction reducing compositions for use in well treatment fluids generally include an aqueous fluid; a polymeric friction reducer; and 3,5-dimethyl-1,3,5-thiadiazinane-2-thione. It has been found that the combination of the polymeric friction reducer; and 3,5-dimethyl-1,3,5-thiadiazinane-2-thione unexpectedly and synergistically increases friction reduction and inversion behavior, where applicable. Also disclosed are methods for the fracturing of a subterranean hydrocarbon bearing formation to stimulate the production of the hydrocarbons by injecting the friction reducing composition.

### BACKGROUND

The present disclosure generally relates to friction reducing compositions for use in well treatment fluids, and more particularly, to friction reducing composition that include the synergistic combination of 3,5-dimethyl-1,3,5-thiadiazinane-2-thione and a polymeric friction reducer.

In the drilling, completion, and stimulation of oil and gas wells, well treatment fluids are often pumped through well bore holes under high pressure and at high flow rates causing the rock formation surrounding the well bore to fracture. The pressure is then relieved allowing the oil to seep through the fractures into the well bore where it is pumped to the surface. The turbulence produced as the fluid is pumped through the pipe under pressure results in the production of friction, thereby increasing the amount of energy required to move the amount of fluid at the same speed.

In order to reduce the friction between the well treatment fluid and the bore linings, friction pressure reducing additives have been combined with the treatment fluids and added during pumping so as to reduce pump pressure. For example, a type of well treatment commonly utilized for stimulating hydrocarbon production from a subterranean zone penetrated by a well bore is hydraulic fracturing. Hydraulic fracturing, also referred to as fracing, is used to initiate production in low-permeability reservoirs and re-stimulate production in older producing wells. In hydraulic fracing, a fluid composition is injected into the well at pressures effective to cause fractures in the structure. Fracing is used both to open up fractures already present in the formation and create new fractures.

Water soluble polymers can be used as friction reducers in well treatment fluids to alter the Theological properties of the fluid so that the turbulent flow is minimized, thereby preventing consequent energy loss in the fluid as it is pumped through the pipe. A good friction reducing polymer will cause a large decrease in friction at small concentrations, will be inexpensive, and will have high shear, temperature and pressure stability.

While aqueous well treating fluids containing friction pressure reducing compositions have been used successfully, there remains a need for improved friction pressure reducing compositions that increase friction reduction, are cost effective, provide long term stability, provide rapid inversion of the polymer, and have high shear, temperature and pressure stability.

### BRIEF SUMMARY

Disclosed herein are friction reducing compositions and methods for fracturing a subterranean hydrocarbon bearing formation to stimulate the production of hydrocarbons from the formation. In one embodiment, the friction reducing composition for use in well treatment fluids comprises an aqueous fluid; a polymeric friction reducer; and 3,5-dimethyl-1,3,5-thiadiazinane-2-thione.

The method for fracturing a subterranean hydrocarbon bearing formation to stimulate the production of hydrocarbons from the formation, the method comprises injecting a pressurized fluid into the subterranean formation from a wellbore passing through the formation at a pressure that is sufficient to hydraulically fracture the formation, wherein the fluid comprises a polymeric friction reducer; and 3,5-dimethyl-1,3,5-thiadiazinane-2-thione.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 graphically illustrates percent friction reduction for fresh water and 2% potassium chloride brine solutions containing different polyacrylamide friction reducers as a function of 3,5-dimethyl-1,3,5-thiadiazinane-2-thione dosage.

FIG. 2 graphically illustrates time as a function of 3,5-dimethyl-1,3,5-thiadiazinane-2-thione dosage for 2% potassium chloride brine solutions containing different anionic polyacrylamide friction reducers.

FIG. 3 graphically illustrates percent friction reduction for fresh water and 2% potassium chloride brine solutions containing a cationic polyacrylamide friction reducer as a function of 3,5-dimethyl-1,3,5-thiadiazinane-2-thione dosage.

FIG. 4 graphically illustrates time as a function of 3,5-dimethyl-1,3,5-thiadiazinane-2-thione dosage for 2% potassium chloride brine solutions containing a cationic polyacrylamide friction reducer.

FIG. 5 graphically illustrates percent friction reduction as a function of time for a 2% potassium chloride brine solution containing 3,5-dimethyl-1,3,5-thiadiazinane-2-thione without any friction reducing polymer.

### DETAILED DESCRIPTION

Disclosed herein are friction reduction compositions for use in well treatment fluid compositions and methods of treating subterranean zones penetrated by well bores. The friction reduction compositions generally include an aqueous solution of a friction reducing polymer and 3,5-dimethyl-1,3,5-thiadiazinane-2-thione. Advantageously, the combination of the polymeric friction reducer and the 3,5-dimethyl-1,3,5-thiadiazinane-2-thione provides an unexpected and synergistic affect so as to provide rapid and enhanced polymer inversion, where applicable, and increased friction reduction, among other advantages. The method for treating a subterranean zone penetrated by a well bore generally includes injecting an aqueous well treatment fluid composition comprising the synergistic friction reducing composition. Thereafter, the aqueous well treatment fluid is pumped into the subterranean zone.

The term “friction reducing polymer” as used herein refers to a polymer that reduces frictional losses due to friction between an aqueous fluid in turbulent flow and tubular goods, e.g., pipes, coiled tubing, and the like, and/or formation. The friction reducing polymer is not intended to be limited to any particular type and may be synthetic polymers, natural polymers, or viscoelastic surfactants. Suitable friction reducing polymers are typically latex polymers or copolymers of acrylamides acrylates, polyisobutylene, guar gum, polyethylene oxide, and combinations thereof. They are added to slick water treatments (water with solvent) at concentrations of 0.1 to 5 pounds per 1,000 gallons of stimulation fluid. In other embodiments, the friction reducing polymer is added at a concentration of 0.25 to about 2.5 pounds per 1,000 gallons of stimulation fluid. The friction reducing polymers may be anionic, cationic, amphoteric, or non-ionic depending on the desired application. In addition various combinations can be used including but not limited to hydrophillic/hydrophobic combinations functionalized natural and/or synthetic and blends of the above, or the like.

The 3,5-dimethyl-1,3,5-thiadiazinane-2-thione is added to the friction reducing polymer in an amount effective to provide the desired amount of friction reduction. Depending on the particular friction reducing polymer as well as water type, the 3,5-dimethyl-1,3,5-thiadiazinane-2-thione can generally be added in an amount of about 1 parts per million (ppm) to about 10,000 ppm, in other embodiments, the 3,5-dimethyl-1,3,5-thiadiazinane-2-thione is added in an amount of about 100 to about 1000 ppm, and in still other embodiments, the 3,5-dimethyl-1,3,5-thiadiazinane-2-thione is added in an amount of 200 ppm to about 350 ppm. It has been observed that the addition of the 3,5-dimethyl-1,3,5-thiadiazinane-2-thione to the friction reducing polymer significantly reduces friction of the well treatment fluid.

The water used to form the friction reducing composition, or the well treatment fluid in general, may be any suitable water for use in well treatments of a wellbore. Without limitation, examples of suitable waters include deionized water, municipal treated water; fresh water; sea water; naturally-occurring brine; a chloride-based, bromide-based, iodide-based, formate-based, or acetate-based brine containing monovalent and/or polyvalent cations; or combinations thereof Examples of suitable chloride-based brines include without limitation sodium chloride and calcium chloride. Further without limitation, examples of suitable bromide-based brines include sodium bromide, calcium bromide, and zinc bromide. In addition, examples of formate-based brines include without limitation sodium formate, potassium formate, and cesium formate.

The well treatment fluid containing the friction reducing composition can be used in any well treatment fluid where friction reduction is desired including but not limited to stimulation and completion operations. For example, the well treatment fluid can be used for hydraulic fracturing applications. Conventional fracturing fluids typically contain natural or synthetic water soluble polymers, which are well known in the art. Water soluble polymers viscosity the aqueous liquids (used hereafter to mean any liquid containing some water) at relatively low concentrations due to their high molecular weight.

In these applications, the fracturing fluid, i.e., well treatment fluid, can be configured as a gelled fluid, a crosslinked gel fluid, a foamed gel fluid, acidic fluids, water and potassium chloride treatments, and the like. The fluid is injected at a pressure effective to create one or more fractures in the subterranean formation. Depending on the type of well treatment fluid utilized, various additives may also be added to the fracturing fluid to change the physical properties of the fluid or to serve a certain beneficial function. In one embodiment, the fluid does not contain a sufficient amount of water soluble polymer to form a gel and consists essentially of the synergistic friction reducing composition. As such, the fracturing fluid has a lower viscosity than traditional fracturing fluids. Optionally, a propping agent such as sand or other hard material is added which serves to keep the fractures open after the fracturing operation. Also, fluid loss agents may be added to partially seal off the more porous sections of the formation so that the fracturing occurs in the less porous strata. Other oilfield additives that may also be added to the fracturing fluid include emulsion breakers, antifoams, scale inhibitors, H₂S and/or O₂ scavengers, biocides, crosslinking agents, surface tension reducers, breakers, buffers, surfactants and non-emulsifiers, fluorocarbon surfactants, clay stabilizers, fluid loss additives, foamers, friction reducers, temperature stabilizers, diverting agents, shale and clay stabilizers, paraffin/asphaltene inhibitors and corrosion inhibitors.

In order to further illustrate the methods and fracturing fluids of the present invention, the following examples are given.

### EXAMPLE 1

In this example, percent friction reduction as a function of 3,5-dimethyl-1,3,5-thiadiazinane-2-thione dosage for various well treatment fluids was measured. The well treatment fluids were formed of fresh water or 2% by weight potassium chloride brine and included anionic polyacrylamide friction reducers A-4330 or A-4332K, commercially available from Kemira Chemicals Inc. The friction reducing polymers were at a concentration of 0.50 gallons per thousand gallon (GPT) of the water or brine. Varying dosages of 3,5-dimethyl-1,3,5-thiadiazinane-2-thione were added to the friction reducing polymer and introduced into a friction loop apparatus.

The friction loop apparatus was a closed loop pipeline designed to measure pressure drop across a five foot section of a stainless steel pipe having a 0.5′ inch nominal diameter. The friction loop was operated at a flow rate of 24 gallons per minute, a temperature of about 85° Fahrenheit, a pipe roughness value of 1.871E-05, and a Reynolds number of about 120,000. Differential pressure was continually measured across the test section at one-second intervals for a period of 10 minutes. The first minute of the test was used to establish a baseline pressure drop. The pressure drop across the five foot section of pipe for the water was calculated from the flow rate and pipe dimensions in accordance with the flowing formula (1):

$$Δ {P}_{water} = \frac{ρ {V}^{2} Lf}{2 {g}_{2} {D}_{h}} , \qquad ( 1 )$$

wherein ΔP_{water} is the calculated pressure drop for water, ρ is density, V is the velocity, L is length, g_{c} is the gravitational constant, and Dh is the pipe diameter. The variable f was calculated in accordance with the formula (2) for turbulent flow below.

$$f = {\{ - 2 log [ \frac{ɛ / d}{3.7} - \frac{5.02}{{N}_{Re}} log ( \frac{ɛ / d}{3.7} + \frac{14.5}{{N}_{Re}} ) ] \}}^{- 2} , \qquad ( 2 )$$

wherein the variable ε is the pipe roughness, the variable d is the pipe diameter, and the variable N_{Re} is the Reynolds Number.

Following addition of the particular anionic friction reducing composition to the tank, the measured was compared to the calculated pressure drop for water to determine a percent friction reduction in accordance with equation (3) below,

$$\% FR = \frac{Δ {P}_{solvent} - Δ {P}_{solution}}{Δ {P}_{solvent}} , \qquad ( 3 )$$

wherein % FR is the percent friction reduction, ΔPₛₒₗᵥₑₙₜ is the pressure drop across the test section for pure solvent (water or test brine), and ΔPₛₒₗᵤₜᵢₒₙ is the pressure drop across the test section for the solution of water or test brine, friction reducer, and biocide.

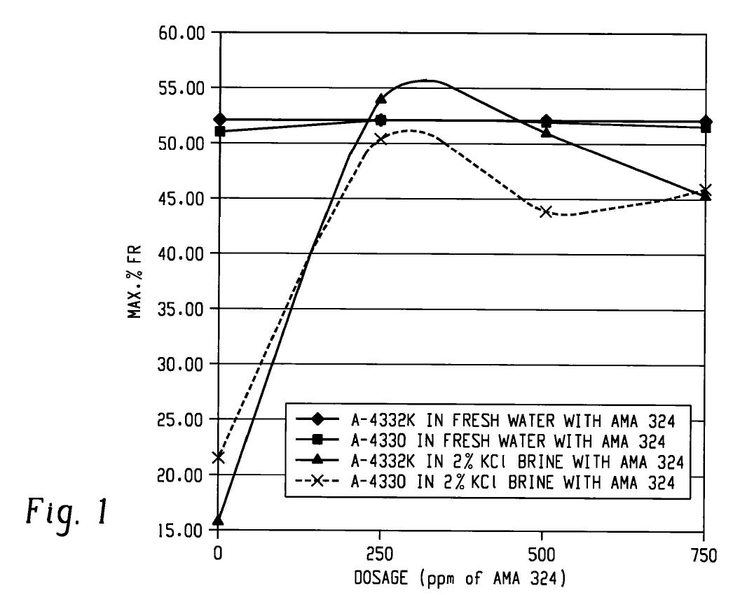

The results are shown in FIG. 1, which clearly shows a marked increase in friction reduction as the dosage of 3,5-dimethyl-1,3,5-thiadiazinane-2-thione is increased to from greater than 0 to about 300 parts per million (ppm). At about 250 to 300 ppm of 3,5-dimethyl-1,3,5-thiadiazinane-2-thione, the well treatment fluids exhibited greater than 50% friction reduction compared to a 15% friction reduction for the well treatment fluids that did not contain 3,5-dimethyl-1,3,5-thiadiazinane-2-thione.

### EXAMPLE 2

In this example, the time to reach maximum friction reduction was measured for 2 weight percent potassium chloride brine well treatment solutions containing polyacrylamide A-4332K or A-4330 as a function of 3,5-dimethyl-1,3,5-thiadiazinane-2-thione dosage at 0.50 GPT. Friction reduction was measured in accordance with Example 1.

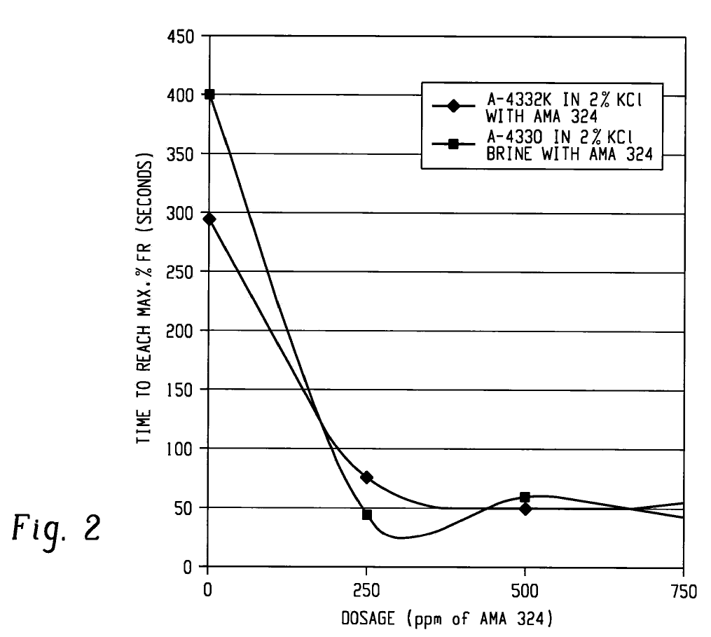

FIG. 2 graphically illustrates the results and shows that the time to reach maximum friction reduction is substantially decreased as a function of increased 3,5-dimethyl-1,3,5-thiadiazinane-2-thione dosage from greater than 0 to about 300 ppm where the time appears to level off. Thus, a six fold decrease in time to maximum friction reduction was observed upon optimizing the amount of 3,5-dimethyl-1,3,5-thiadiazinane-2-thione in the well treatment dosage compared to well treatment fluids without the 3,5-dimethyl-1,3,5-thiadiazinane-2-thione.

### EXAMPLE 3

In this example, maximum friction reduction was measured for a 2 weight percent potassium chloride brine well treatment solution containing cationic polyacrylamide C 4803 LV commercially available from Kemica Chemicals Inc. at a dosage of 0.50 GPT as a function of 3,5-dimethyl-1,3,5-thiadiazinane-2-thione dosage. Friction reduction was measured in accordance with Example 1.

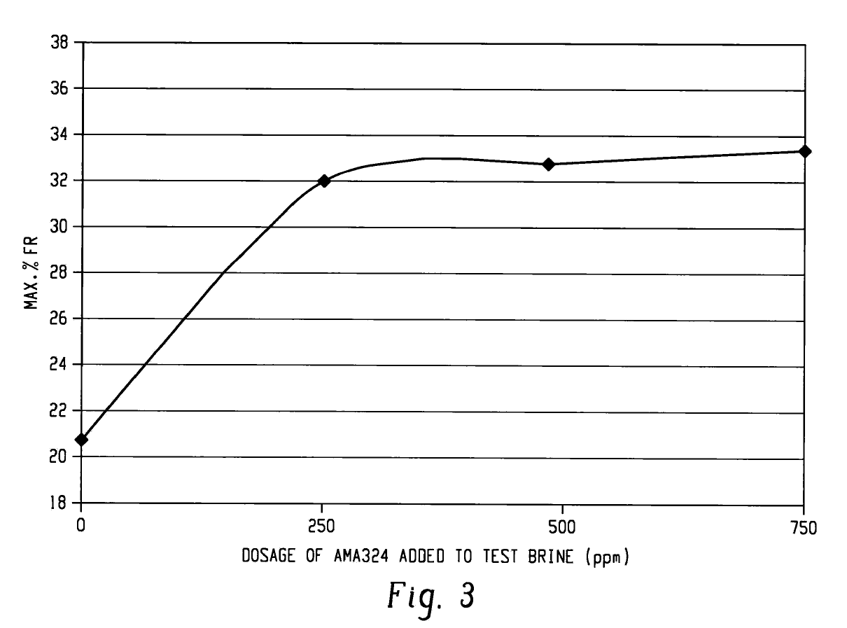

FIG. 3 graphically illustrates that maximum friction reduction occurred at about 250-300 ppm of 3,5-dimethyl-1,3,5-thiadiazinane-2-thione, which represented almost double the maximum friction reduction obtained by brine fluid containing the cationic friction reduction polymer without the 3,5-dimethyl-1,3,5-thiadiazinane-2-thione.

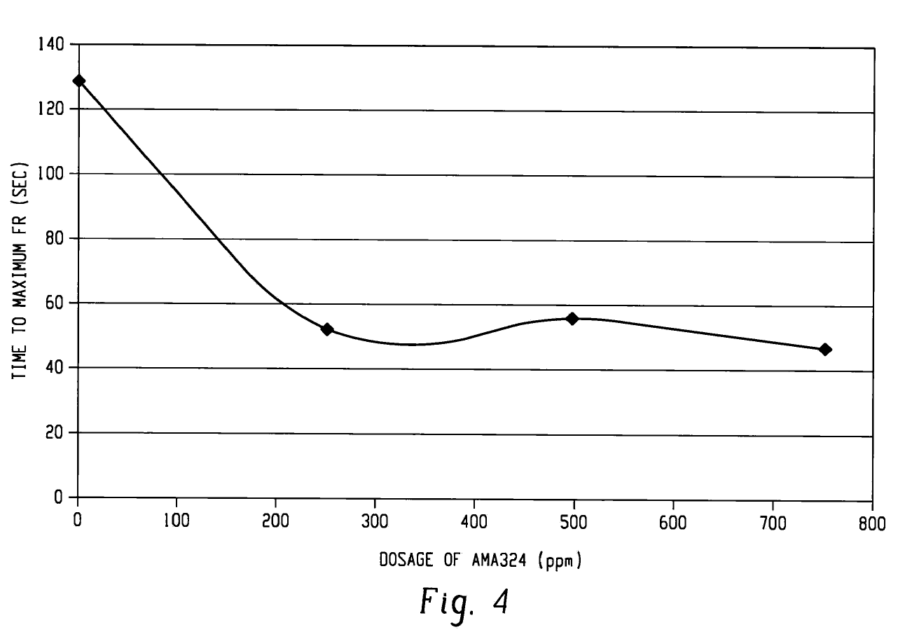

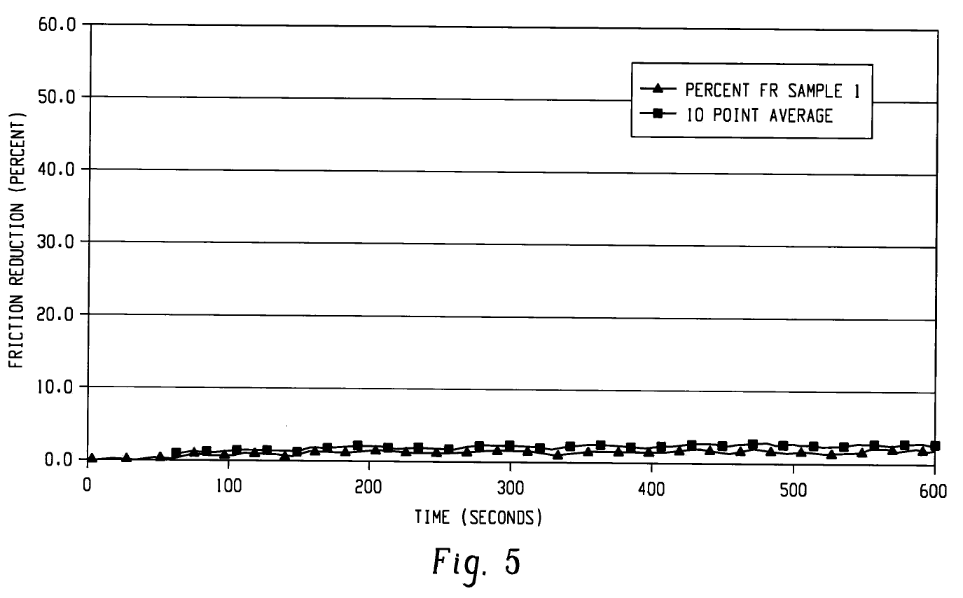

FIG. 4 shows the inversion time enhancement by 3,5-dimethyl-1,3,5-thiadiazinane-2-thione on the cationic polymer 4803LV follows the same trends as noticed for the anionic polymers in FIG. 2. FIG. 5 is the graph of biocide alone that Noora forwarded.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A friction reducing composition for use in well treatment fluids, the composition comprising:
an aqueous fluid;
a polymeric friction reducer; and
3,5-dimethyl-1,3,5-thiadiazinane-2-thione.

2. The friction reducing composition of claim 1, wherein the polymeric friction reducer is a cationic polymer.

3. The friction reducing composition of claim 1, wherein the polymeric friction reducer is a anionic polymer.

4. The friction reducing composition of claim 1, wherein the polymeric friction reducer is a non-ionic polymer.

5. The friction reducing composition of claim 1, wherein the polymeric friction reducer is an amphoteric polymer.

6. The friction reducing composition of claim 1, wherein the aqueous fluid comprises deionized water, municipal treated water; fresh water; sea water; naturally-occurring brine; a chloride-based, bromide-based, iodide-based, formate-based, or acetate-based brine containing monovalent and/or polyvalent cations; or combinations thereof.

7. The friction reducing composition of claim 1, wherein the polymeric friction reducer comprises latex polymers or copolymers of acrylamides, acrylates, polyisobutylene, guar gum, native or functionalized polysaccharide, polyethylene oxide and combinations thereof.

8. The friction reducing composition of claim 1, wherein the 3,5-dimethyl-1,3,5-thiadiazinane-2-thione is in an amount of about 1 parts per million (ppm) to about 10,000 ppm.

9. A method for fracturing a subterranean hydrocarbon bearing formation to stimulate the production of hydrocarbons from the formation, the method comprising:
injecting a pressurized fluid into the subterranean formation from a wellbore passing through the formation at a pressure that is sufficient to hydraulically fracture the formation, wherein the fluid comprises water; a polymeric friction reducer; and 3,5-dimethyl-1,3,5-thiadiazinane-2-thione.

10. The method of claim 9, wherein the polymeric friction reducer is a cationic polymer.

11. The method of claim 9, wherein the polymeric friction reducer is an anionic polymer.

12. The method of claim 9, wherein the polymeric friction reducer is a non-ionic polymer.

13. The method of claim 9, wherein the polymeric friction reducer is an amphoteric polymer.

14. The method of claim 9, wherein the polymeric friction reducer comprises latex polymers or copolymers of acrylamides acrylates, polyisobutylene, guar gum, polyethylene oxide and combinations thereof.

15. The method of claim 9, wherein the fluid further comprises a proppant agent.

16. The method of claim 9, wherein the pressurized fluid reduces friction without forming a gel.

17. The method of claim 9, wherein the pressurized fluid is at a pressure effective to create one or more fractures in the subterranean formation.

18 The method of claim 9, wherein the 3,5-dimethyl-1,3,5-thiadiazinane-2-thione is in an amount of about 1 parts per million (ppm) to about 10,000 ppm.

19. The method of claim 9, wherein the water comprises deionized water, municipal treated water; fresh water; sea water; naturally-occurring brine; a chloride-based, bromide-based, or formate-based brine containing monovalent and/or polyvalent cations; or combinations thereof.

20. The method of claim 9, wherein the polymeric friction reducer is at a concentration of 0.1 to 5.0 pounds per 1,000 gallons of the water, and the 3,5-dimethyl-1,3,5-thiadiazinane-2-thione is in an amount of about 1 parts per million (ppm) to about 10,000 ppm.

21. A well treatment fluid, consisting essentially of:
an aqueous fluid;
a polymeric friction reducer; and
3,5-dimethyl-1,3,5-thiadiazinane-2-thione.

22. The well treatment fluid of claim 21, wherein the polymeric friction reducer is at a concentration of 0.1 to 5.0 pounds per 1,000 gallons of the water, and the 3,5-dimethyl-1,3,5-thiadiazinane-2-thione is in an amount of about 1 parts per million (ppm) to about 10,000 ppm.
